(19) United States
(12) Patent Application Publication
(10) Pub. No.: US 2024/0249121 A1
(43) Pub. Date: Jul. 25, 2024

(54) Lookup Tables for Ultra Low-Bit Operations

(71) Applicant: Deeplite Inc., Montreal (CA)

(72) Inventors: Muhammad Saad ASHFAQ, Toronto (CA); Saptarshi MITRA, Toronto (CA); Alexander HOFFMAN, Montreal (CA); Darshan Chandrashekhar GANJI, Toronto (CA); Ahmed HASSANIEN, Montreal (CA); Sudhakar SAH, Markham (CA); Ehsan SABOORI, Richmond Hill (CA); MohammadHossein ASKARI HEMMAT, Montreal (CA)

(73) Assignee: Deeplite Inc., Montreal (CA)

(21) Appl. No.: 18/417,285

(22) Filed: Jan. 19, 2024

Related U.S. Application Data
(60) Provisional application No. 63/480,725, filed on Jan. 20, 2023.

(51) Int. Cl. G06N 3/0464

(52) U.S. Cl. CPC G06N 3/0464

(57) ABSTRACT

A system, method and computer readable medium for implementing neural networks. The method can include providing a neural network, providing a lookup table based on the neural network, packing weights and activations of the neural network associated with the at least one convolution with a first set of bitwise operations, unpacking the packed weights and activations, with a second set of bitwise operations, to determine one or more inputs for the look up table. The method includes accessing, within the lookup table, an output corresponding to the one or more inputs, and implement the at least one convolution based on the output.

### CROSS-REFERENCE TO RELATED APPLICATION(S)

This application claims priority to U.S. Provisional Patent Application No. 63/480,725 filed on Jan. 20, 2023, the contents of which are incorporated herein by reference in their entirety.

### TECHNICAL FIELD

The following generally relates generally to implementing neural networks, and particularly to low bit environment operators.

### BACKGROUND

Operators for ultra-low bit computing environments (i.e., sub 8-bit environments) may not be efficiently executed to implement deep learning machine learning operations on mainstream central processing unit (CPU) architectures, as these architectures do not support sub 8-bit instructions. For example, operators for ultra-low bit computing environments are not supported by the vectorized instruction sets of mainstream CPU architectures including x86 (SSE/AVX SIMD instructions (as these terms are defined herein)) and Arm (Neon SIMD instructions). In other than ultra-low bit environments, deep learning workloads are instead typically accelerated on CPUs by exploiting data-level parallelism through single instruction, multiple data (SIMD) programming. These approaches cannot be implemented in ultra-low bit environments. Therefore, currently, there are no ultra low-precision model deployments available on general-purpose processors (GPPs).

Prior efforts on low-bit implementation of convolutional neural networks (CNNs) on GPPs have primarily focused on 8-bit (INT8) quantization. QNNPACK (Dukhan et al., 2018) is a library that provides high performance convolution kernels for 8-bit quantization targeting both x86 and Arm architectures. It supports the quantization of 2D convolutions, fully connected, pooling, ReLU and softmax layers. It is integrated within the PyTorch framework. NCNN (Tencent, 2020) provided by Tencent also supports 8-bit quantization, and implements convolution layers using general matrix multiply (GEMM) algorithms. Gemmlowp (Jacob et al., 2017) can also be used for optimized implementation of quantized GEMM algorithms. The CMSIS-NN framework (Lai et al., 2018) also proposes an optimized implementation of convolution kernels for Cortex-M CPUs.

Fewer attempts have been made to implement quantization with fewer than 8-bits. (Tulloch & Jia, 2017) propose an implementation based on bitwise ANDs and popcount instruction to perform the elementary operations of the convolutions. Indeed, if weights and activations are represented with a single bit, a multiplication can be implemented as an AND, and popcount can be used for accumulation. By adding shifts to the equation, one can also support 2-bit or 3-bit operations enabling efficient data parallelism and lower latency compared to standard higher precision operators. Nevertheless, the packing operation can be costly and may hinder the performance improvement.

Another framework that increases the speed of GEMM processing at ultra low-precision is ULPPACK (Won et al., 2022). Depending on the number of bits, this implementation is shown to achieve better performance than the bit-serial method. The principle is to pack multiple sub-byte weight and activation values within an 8-bit integer. Then a regular 8-bit multiply operation produces the expected dot-product result. This principle can be further used to 16-bit and 32-bit multiply operations with even more inputs. Full networks are implemented using this technique, and it is shown that ULPPACK outperforms other low-bit implementations such as QNNPACK, gemmlowp, and the bit-serial version.

(Han et al., 2020) have also proposed an implementation of extremely low-bit quantization of CNNs. The performance gains are achieved with a clever usage of multiply-accumulate (MAC) operations that are vectorized using the Neon instruction set, reducing the number of cycles needed to perform a single convolution. Throughput gains are quite significant and are even observed for 4-8 bits, while (Cowan et al., 2020) had only reported gains with 1-3 bits quantization.

### SUMMARY

This disclosure relates to a system, method and computer readable instructions which include the use of precalculated tables and lookup operations with one or more convolution kernels that utilize the SIMD instructions in commonly available processors to. The arrangement of precalculated tables and lookup operations replaces costly multiply-accumulate (MAC) operations prevalent in deep learning models with faster precomputed data retrieval from a lookup table (LUT) provided that the table is small enough to fit within the processor cache or registers.

To potentially address the defects in existing approaches, this disclosure proposes Extremely low-bit computations using lookup tables on CPUs with SIMD support. This disclosure also relates to flexible ultra low-precision convolution operators compatible with uniform and non-uniform quantization techniques.

In one aspect, there is provided a method for implementing neural networks. The method includes providing a neural network including at least one convolution, and providing a lookup table for implementing the at least one convolution. The method includes packing weights and activations of the neural network associated with the at least one convolution with a first set of bitwise operations, and unpacking the packed weights and activations, with a second set of bitwise operations, to determine one or more inputs for the lookup table. The method includes accessing, within the lookup table, an output corresponding to the one or more inputs; and implement the at least one convolution based on the output.

In example embodiments, the first set and the second set of bitwise operators consist of at least one of bitwise shift, bitwise OR, and bitwise shuffle operations.

In example embodiments, the method further comprises quantizing the neural network prior and determining the lookup table based on the quantized neural network.

In example embodiments, the lookup table is used in combination with transformed convolution. The quantization can be one of uniform or non-uniform.

### BRIEF DESCRIPTION OF THE DRAWINGS

Embodiments will now be described with reference to the appended drawings wherein:

FIGS. 1A, and 1B illustrate example packing and unpacking approaches, and components thereof, for discussing a simplified lookup table based approach in accordance with the disclosure herein.

FIG. 2 is a block diagram illustrating a method of implementing a neural network with the lookup table based approach disclosed herein.

FIG. 3 is another block diagram illustrating a method of implementing a neural network with the lookup table based approach disclosed herein.

FIGS. 4A and 4B illustrate an example method of processing weights and activations for use with SIMD operations on a lookup table with 16 entries and 216 entries, respectively.

FIG. 5 is an example computer code listing to implement approaches as described herein.

FIG. 6 is an example of a 16 bit indices for use with an example LUT based approach.

FIGS. 7A, 7B, 7C, and 7D display four different example packing schemes for implementing neural networks.

FIG. 8 is another example computer code listing to implement approaches as described herein

FIG. 9 is a graph illustrating a comparison between of latency an implementation according to the disclosure and another implementation.

FIG. 10 is a graph illustrating a comparison of speed between an implementation according to the disclosure and another implementation.

FIG. 11 is a graph illustrating a comparison of timing between different implementations according to the disclosure.

FIG. 12 is another graph illustrating a comparison of timing between other implementations according to the disclosure.

FIGS. 13A, 13B, 13C, and 13D are illustrations of a proposed hardware configuration for implementing the approach described herein.

FIG. 14 is a block diagram illustrating a system configuration where the proposed approach can be used.

### DETAILED DESCRIPTION

To quantize data is to represent it using a countable number of bits. Typically, real values are represented in a 32-bit floating point (FP32) format. It is possible to reduce this number and to represent the values with fewer bits. The advantages of reducing the number of bits include a smaller memory footprint and lower computational complexity. These advantages typically lead to increased performance (e.g., lower latency, higher throughput, better energy efficiency, etc.). The term quantization defines the process of converting 32 bit floating point numbers into lower precision representations. Dequantization defines the opposite process.

There are two main families of quantization techniques: uniform and non-uniform. To explain the difference between uniform and non-uniform quantization techniques, some context will be provided below.

In convolutional neural networks, the inputs to the convolutions are feature maps. In the example of image processing, the inputs are tensors of padded activations data X∈ [symbol] ^{N×C}^{ᵢ}^{×(H+2)×(W+2)}, where N is the batch size, Cᵢ is the number of input channels, H is the height of the input feature maps, and W is the width of the input feature maps. Usually, these inputs are first padded with zeros in order to maintain the height and width of the convolution outputs. These inputs are convolved with W∈ [symbol] ^{C}^{ₒ}^{×C}^{ᵢ}^{×K×L}, where Cₒ is the number of weights output feature maps, and the output is γ∈ [symbol] ^{N×C}^{ₒ}^{×H×W}.

The elements of this output tensor γ are calculated as:

$${y}_{n , {c}_{o} , h , w} = {\sum }_{{C}_{i} = 0}^{{C}_{i} - 1} {\sum }_{k = 0}^{K - 1} {\sum }_{l = 0}^{L - 1} {x}_{n , {c}_{i} , h + k , w + l} \cdot {w}_{, {c}_{o} , {c}_{i} , k , l} \qquad ( 1 )$$

For simplicity, if the different indices are flattened, the computation of a single element of the vector γ is

$$y = {\sum }_{{C}_{i} = 0}^{{C}_{i} KL - 1} {x}_{i} \cdot {w}_{i} \qquad ( 2 )$$

In uniform quantization, the quantized values correspond to integers and there is a linear relation between intervals in the quantized and in the real domain. Two parameters are needed to define a particular quantization process, which are a scaling factor s∈ [symbol] and the zero-point z∈ [symbol] which is the integer value to which the real value zero is mapped. In example embodiments, x_{q}∈{−2^{b-1}, −2^{b-1}+1, . . . , 2^{b-1}}, and the quantized version of x∈ [symbol] is defined with the following transformation: x_{q}=quantize(x)=clip(round(s·x+z, −2^{b-1}, 2^{b-1}−1). This general uniform quantization is called affine quantization. A subset of this quantization is scale quantization, in which z=0 and the quantization process is symmetric.

The direct advantage of uniform quantization is that operations on real values can be transformed into operations on integer values. For example, in the case of the convolution as defined in Equation (2).

$$y = {\sum }_{{C}_{i} = 0}^{{C}_{i} KL - 1} {x}_{i} \cdot {w}_{i} \approx \qquad ( 3 )$$

$${\sum }_{{C}_{i} = 0}^{{C}_{i} KL - 1} dequantize ( {x}_{q} , {s}_{x , i} ) \cdot dequantize ( {w}_{q} , {s}_{wj} ) \qquad ( 4 )$$

$${\sum }_{{C}_{i} = 0}^{{C}_{i} KL - 1} \frac{1}{{s}_{x , i}} {x}_{q} \cdot \frac{1}{{s}_{w , i}} {w}_{q} \qquad ( 5 )$$

And, if the scaling factors are constant for the whole layer, the latter equation can be further simplified to:

$$\frac{1}{{s}_{x , i}} \frac{1}{{s}_{w , i}} {\sum }_{{C}_{i} = 0}^{{C}_{i} KL - 1} {x}_{q} \cdot {w}_{q} \qquad ( 6 )$$

in which all the operations have been transformed into integer operations, leading to possible simplified and optimized implementations with integer processing hardware.

It is also possible to perform non-uniform quantization, in which the transformation to integer arithmetic is lost, but the mean quantization error is reduced by fitting the considered distribution of weights and activations.

### 2.2 Convolutional Layers

Convolutional layers in convolutional neural networks (CNNs) may be performed using computational transforms to change the elementary operations applied to the input data. A first option is to use matrix multiplication with Toeplitz matrices (Sze et al., 2017). The principle involves replicating the input feature maps. As many optimized implementations exist for matrix multiplication, such implementations tend to be very efficient. However, the redundancy from input replication leads to high memory usage and complex memory access patterns.

Another possibility is to use winograd transforms. This algorithm involves the re-association of operations on the input data, which leads to reduced number of multiplications required to process the convolution. It is also possible to use Fast Fourier Transforms (FFTs) to accelerate the convolutions. The FFT must be applied to both the input feature maps and the weights before the resulting matrices are element-wise multiplied in the frequency domain and finally an inverse FFT will produce the outputs of the convolution.

In this disclosure, one focus is on direct convolution to implement convolutional layers. However, the disclosed lookup operations and pre-calculated tables can be used can be adapted to transformed convolutions as well. In the case of matrix multiplications, one must also perform multiply-accumulate operations as is the case for direct convolution. Winograd transform could also be performed on 2-bit data, before a final use of the lookup table in the last computation step. The disclosed lookup operations and pre-calculated table can be use for FFT based implementations as well.

### 3 DEEPGEM

### 3.1 Data Layout

Any implementation of operators requires selecting an organizing principle for data in memory (e.g., data such as weight and activation values). Memory's unidimensional design reduces the selection to a selection of the axes and the order in which the data in a multidimensional array should be arranged. Generally, in the example of image processing, the data layout is chosen to be either NCHW or NHWC where the letters in the abbreviation stand for: N, Number of data samples; C, data channels. In a red-green-blue (RGB) image, there are three (3) channels; H, Image height; W, Image width.). The crucial choice is whether the last dimension should be the data width or channels. This disclosure contemplates accumulating along the channel axis and thus organizing the data in the NHWC format. The main advantage of this layout is reduction in the number of intermediate variables during processing, which can lead to less memory congestion in the vector registers.

### 3.2 Integer Vs Floating-Point Look Up Table

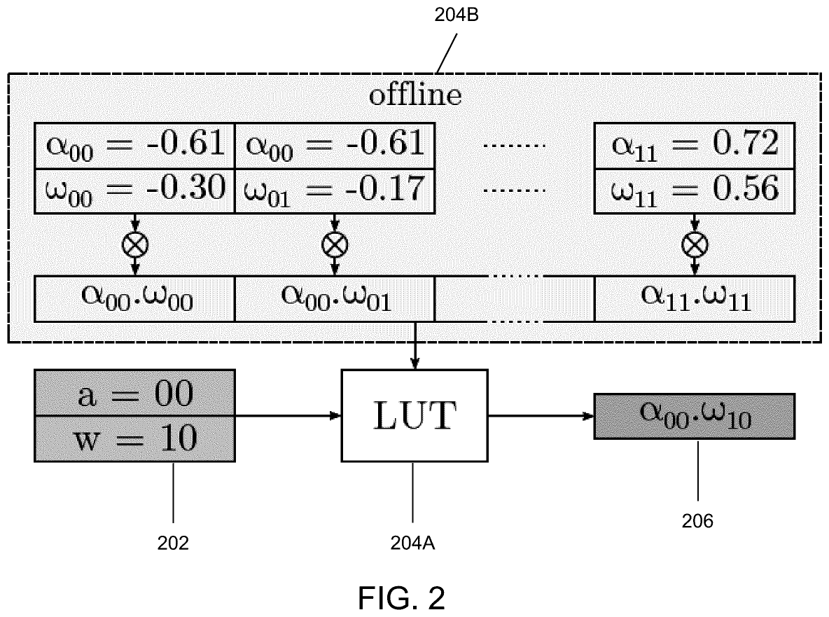

In contrast to other methods in the literature for ultra low-bit computations, the proposed look up operations and pre-calculated table (hereinafter referred to as “the LUT”, for simplicity) approach works for both uniform and non-uniform quantization techniques. With uniform quantization, one can store either floating point or integer values in the lookup table. For non-uniform quantization, one must store floating point values to avoid costly dequantization operations. FIG. 2 depicts an example floating point LUT which is compatible with either uniform or non-uniform quantized weights and activations.

### 3.3 Overview of the Proposed LUT Algorithm

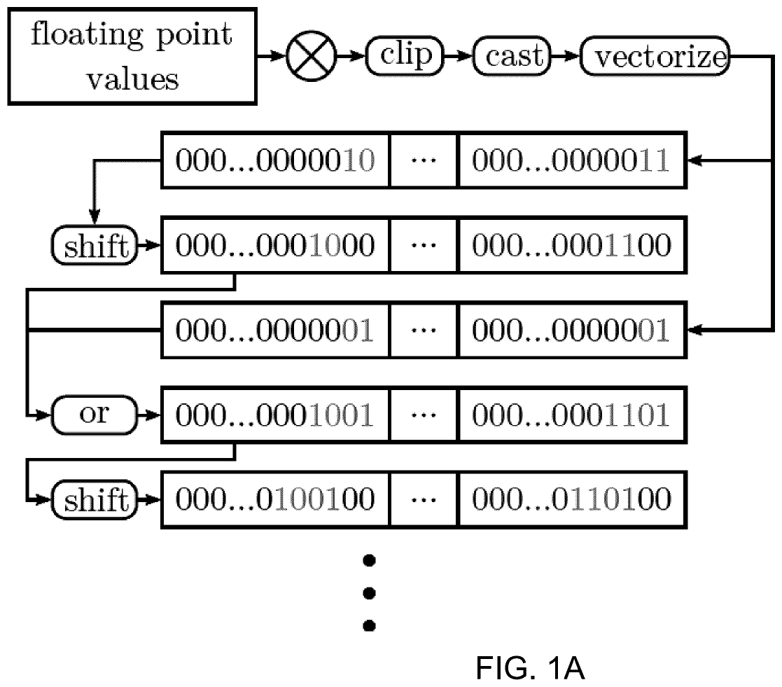

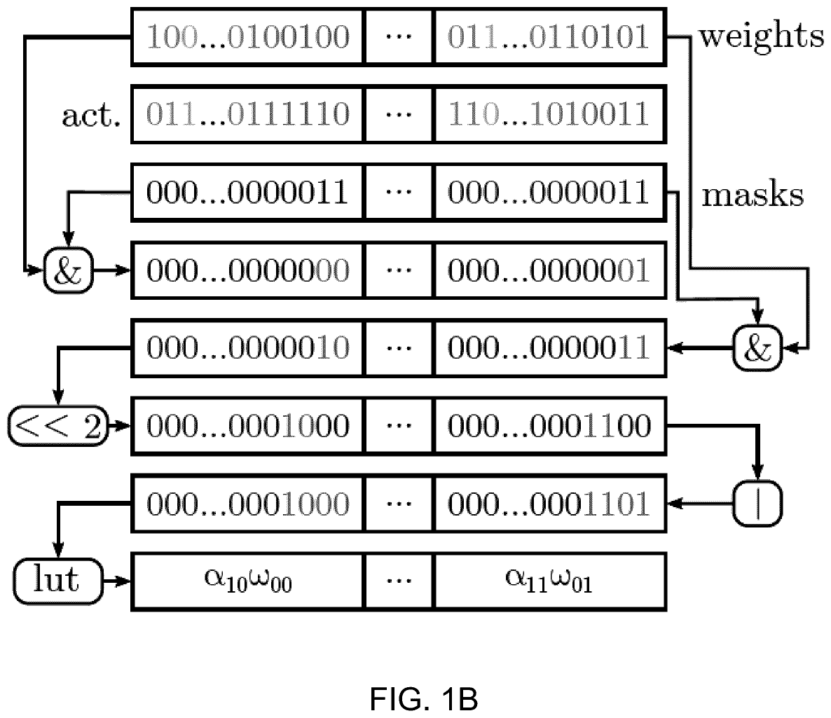

The proposed LUT algorithm is composed of 3 parts: packing, unpacking and LUT access. Packing includes providing multiple low bit values in a higher precision data type. FIG. 1A depicts the packing of 32 2-bit values within a 64-bit data type. In FIG. 1A, bitwise shift and OR operations are performed for packing.

Unpacking includes extracting the low-bit values from the packed representation and using the extracted values for LUT access. FIG. 1B illustrates the unpacking step with masking and shift operations. Both packing and unpacking steps only use simple bitwise operations that typically offer low latency and high throughput. All three parts of the proposed LUT kernel have been vectorized.

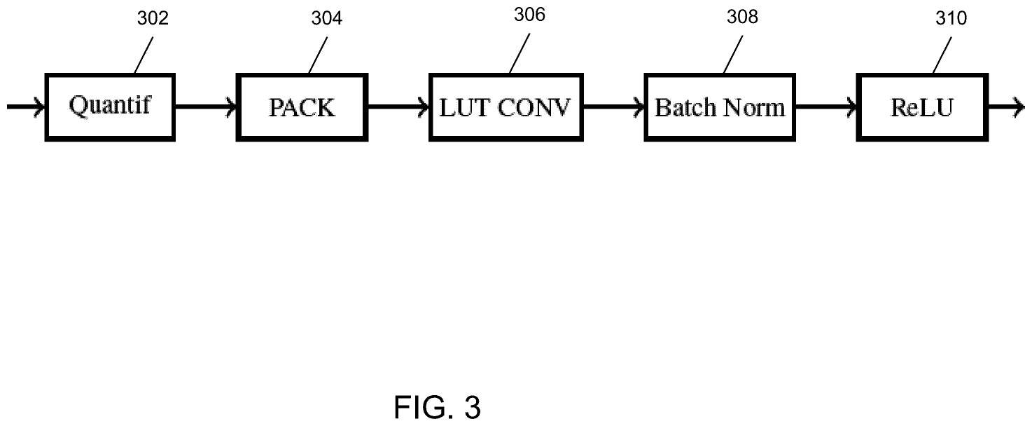

FIG. 3 shows an example block diagram illustrating a method of implementing a neural network with the lookup table based approach disclosed herein. At block 302, the input neural network (not shown) is quantized. At block 304, at least some components of the neural network are packed. At block 306, the packed components are unpacked and the LUT is accessed. At block 308, the various convolutions are added together, and used as an input into block 310 to see if they trigger the activation threshold.

### 3.4 Vectorized Lookup

This disclosure can include replacing the MAC operations that are performed in convolution kernels with lookup table accesses. Two example embodiments of a LUT based approach are considered in detail herein: the first uses SIMD operations on a lookup table with 16 entries while the second uses a lookup table with 216 entries. In both cases, the weight and activation values are quantized to 2 bits. It is understood that the disclosure is not limited to the two example embodiments discussed, and that modifications can be made.

The example embodiments are intended to be implemented on x86 CPUs with AVX2 SIMD instructions with 256-bit long vector registers. For both embodiments, the lookup table entries are 8-bit values, which implicitly assumes that the result of the MAC operations will not overflow 8 bits. If required, higher precision data types can be chosen for the lookup table entries to account for larger accumulation results to be stored in the table.

### LUT-16

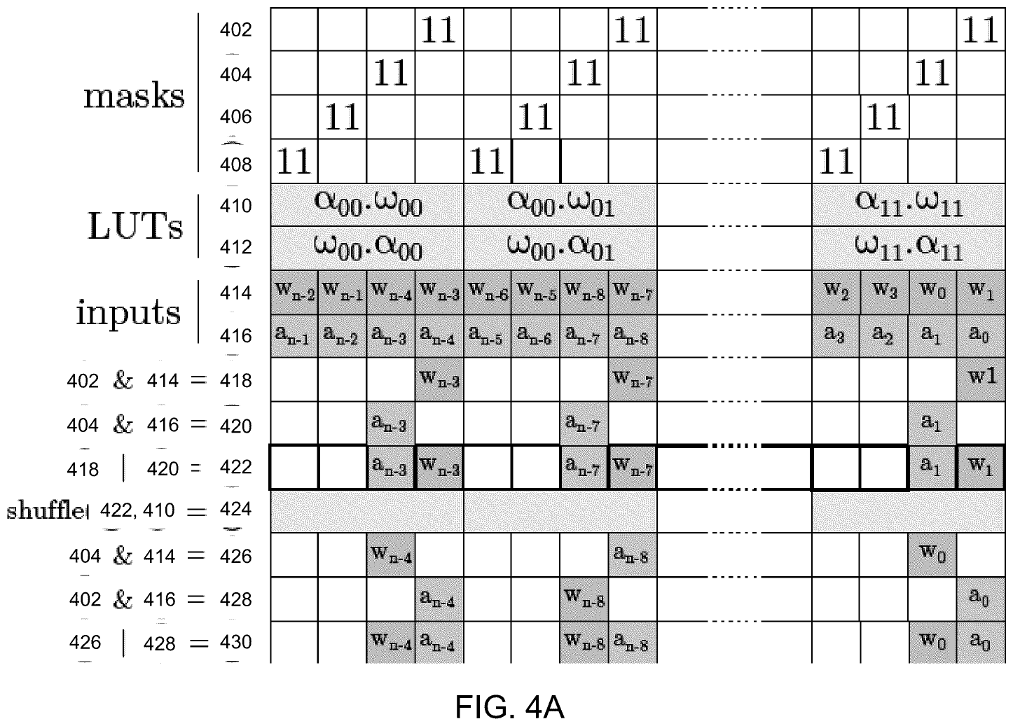

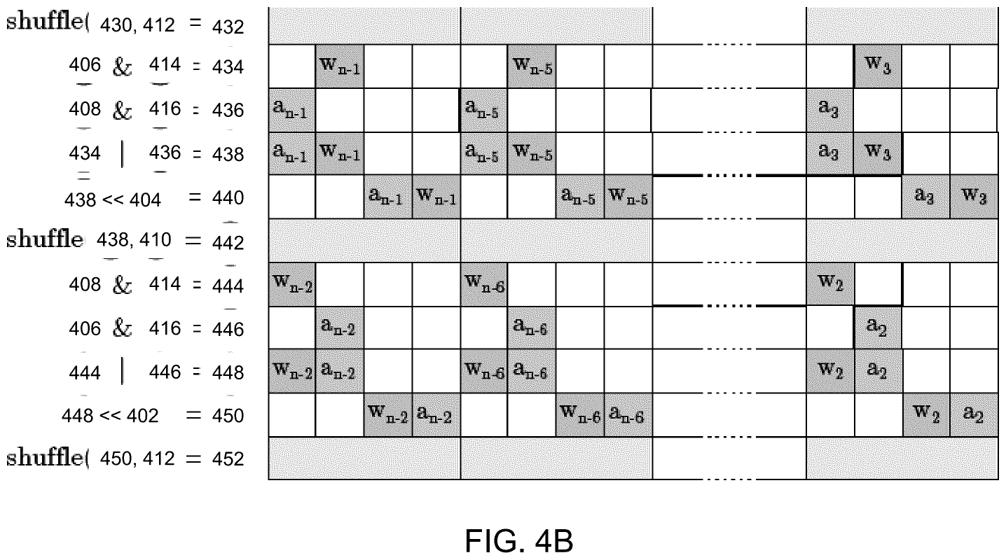

In the LUT-16 version shown in FIGS. 4A, and 4B two (2) lookup tables are stored in a single vector register. The values stored in the LUT are all possible results of w·a, with w∈{ω00,ω01,ω10,ω11} and any a∈{α00,α01,α10,α11}. Notably, the weights 414 are reordered so that after masking, the resulting vectors 418 and 420 can be directly combined with an OR operation, without additional shifting needed. This is cost-less at inference time, because the weights rearrangement can be performed offline.

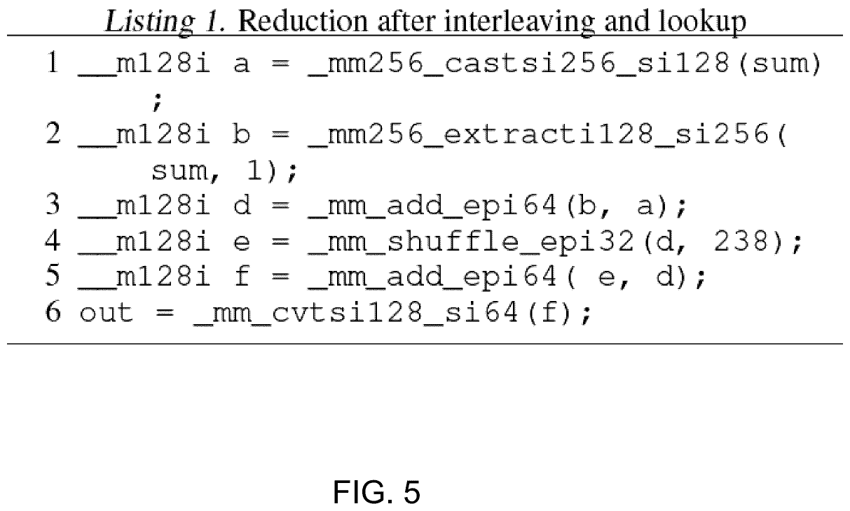

The resulting values of this process are 4 vector registers that contain 8-bit dot products (424, 432, 442, 452). A vectorized sum of the 8-bit elements is performed between these 4 registers. The final operation is to do a horizontal addition of these values. The AVX2 implementation of this reduction is detailed in Listing 1, as shown in FIG. 5.

Upon close inspection, it can be inferred that the number of instructions to perform the convolution with the LUT approach is actually comparable to the FP32 baseline. For each pair of weight and activation values, an operation is performed in both cases: a shuffle for the proposed ultra low-bit LUT method and a multiplication for the standard FP32 method. When loading vector registers with weight and activation inputs, the number of values loaded in a register is given by the vector register size (R) divided by the data size. For 2-bit quantized values with the LUT approach, R/2 values can be loaded in a register whereas in the case of FP32 data, only R/32 values can be loaded (R/8 in the case of 8-bit quantized data). Therefore, in addition to the latency of shuffle being lower than multiplication, the observed gains with the LUT method also result from substantially fewer exchanges between the cache and the vector registers.

### LUT-65k

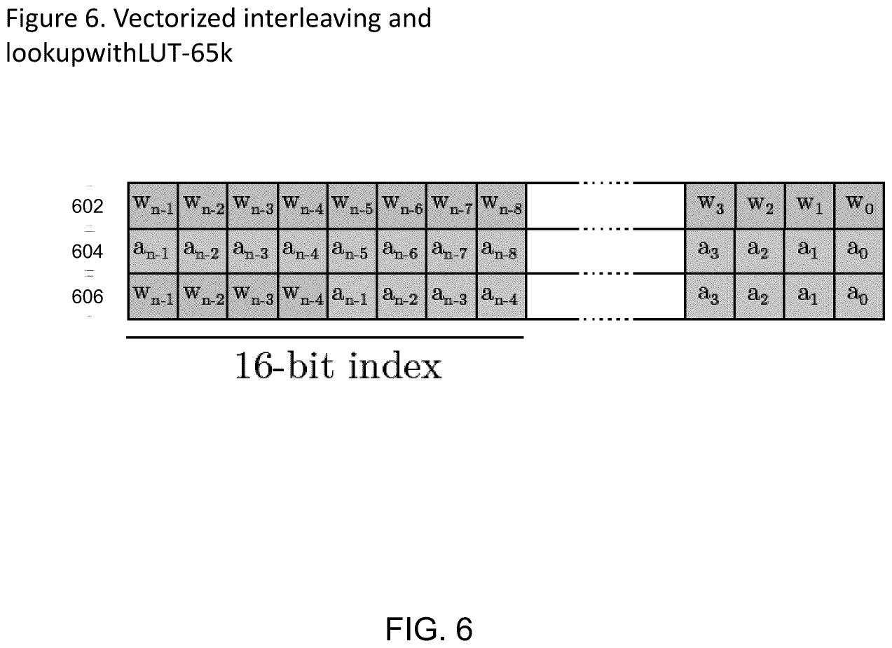

In the LUT-65k version, a lookup table of size 28 2-bit elements is created. Each element corresponds to each possible combination of the dot product between 4 weights and 4 activations. This lookup table can be stored in cache, as it fits in a typical L1 cache on modern processors. Therefore the process that must be performed on input weights and activations is the generation of 16-bit indices for the LUT, as shown in FIG. 6.

### 4 IMPLEMENTATION DETAILS

### Packing Schemes

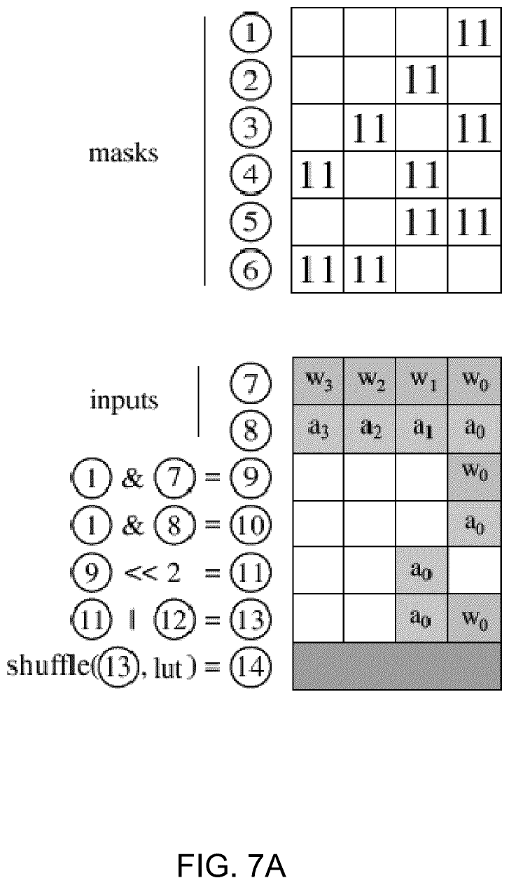

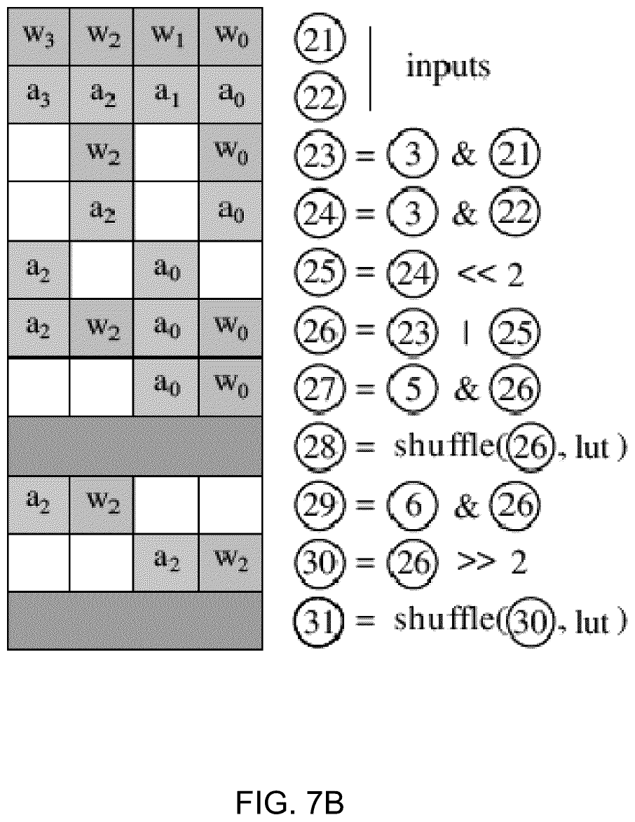

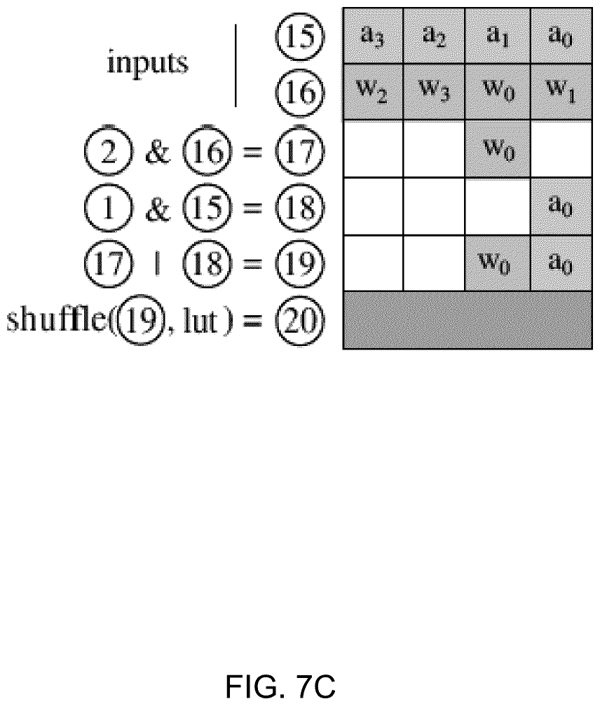

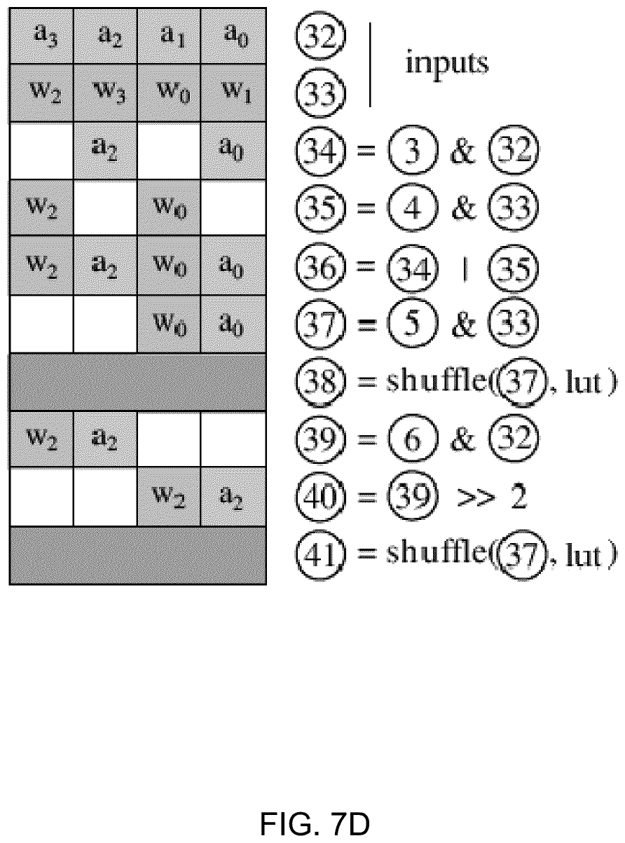

Several packing schemes were experimented with in order to reduce the unpacking overhead. FIGS. 7A, 7B, 7C, and 7D display four different packing schemes. The scheme shown in FIG. 7B is derived from the scheme in FIG. 7A and the scheme FIG. 7D is derived from the scheme in FIG. 7C. Among the 4, the scheme in FIG. 7D results in the least overhead for the unpacking step followed by the schemes shown in FIGS. 7B, 7C, 7A. Table 1 (shown below) lists the number of instructions required for these four packing methods.

TABLE 1

| Instruction/Packing Scheme | A | B | C | D |
|---|---|---|---|---|
| And | 2 | 4 | 2 | 4 |
| Shift | 1 | 2 | 0 | 1 |
| OR | 1 | 1 | 1 | 1 |
| Shuffle | 1 | 2 | 1 | 2 |
| No of outputs at once (within 8 bits) | 1 | 2 | 1 | 2 |

### Proposed Algorithm

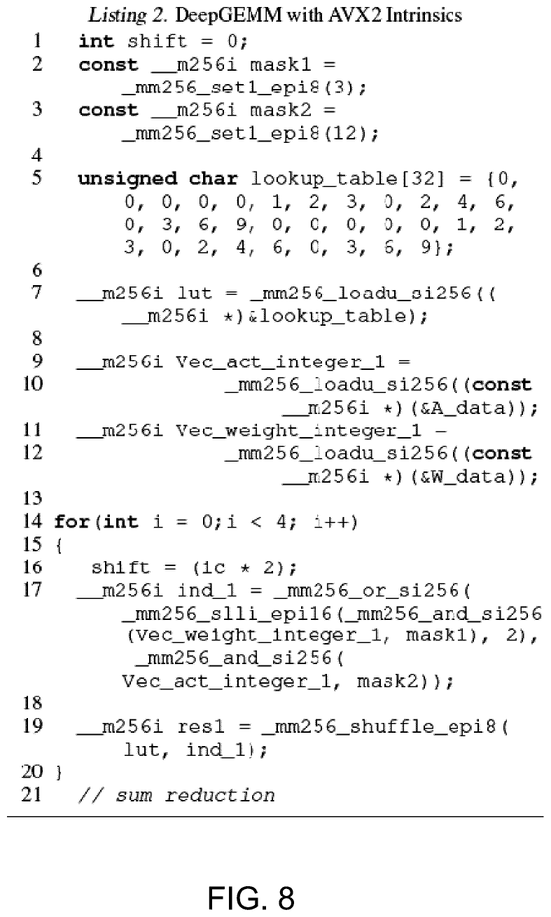

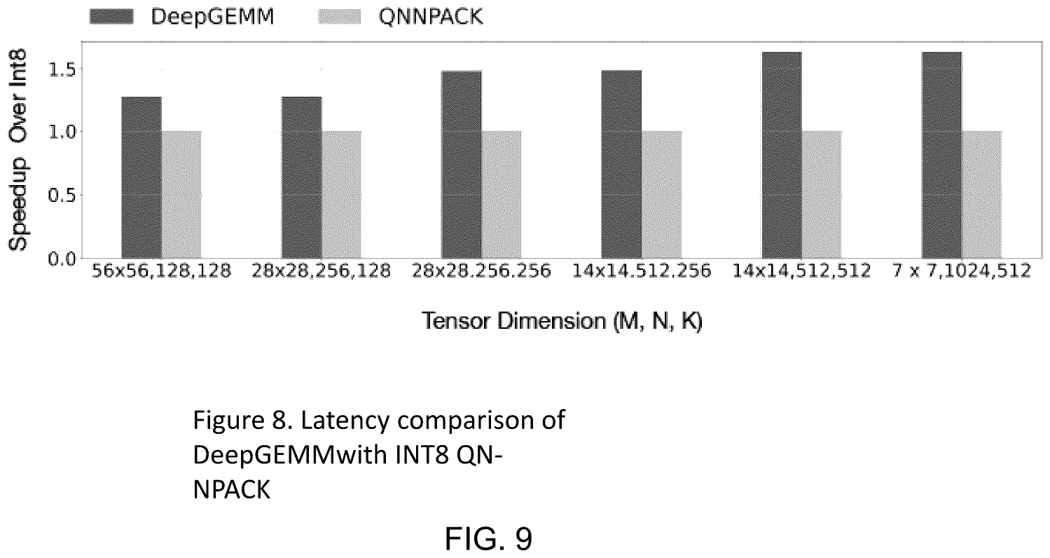

The AVX2 shuffle instruction was used to perform the vectorized lookup operations. 32 lookups were executed at a time within a 256-bit vector register. Listing 2 shown in FIG. 8 shows a simplified C implementation of the proposed algorithm using AVX2 intrinsics. The precomputed products are stored in the LUT at line 5. The already packed activation and weight values are loaded into 256-bit vector registers in lines 9 and 12, respectively. The unpacking of inputs to generate the index for LUT access happens at line 17. Finally, the lookup table is accessed to retrieve the pre-computed product of the input values in line 19. The sum reduction of the LUT values is the last step before storing the accumulated dot product results. Unlike Neon, AVX2 does not offer an instruction that can be utilized for the horizontal vector sum; the group of instructions that were utilized for this reduction step are given in Listing 1 in FIG. 5.

### 5 EXPERIMENTAL RESULTS

### 5.1 Setup

Table 2 (below) lists the test configurations that were used to profile the ultra low-precision LUT kernels. All the experimental results in this section include the overhead of packing activations but not the cost of packing weights as they can be packed offline prior to inference.

TABLE 2

| | | |
|---|---|---|
| Architecture | x86 | Arm |

| | | |
|---|---|---|
| Processor | i7-9700k | ArmCortex-A72 |
| | 8 cores@3.6 GH | 4 cores@1.5 GHz |

| | | | | |
|---|---|---|---|---|
| L1 | 32 | KB | 32 | KB |
| L2 | 256 | KB | 1 | MB |
| L3 | 12.5 | MB | | |

| | | |
|---|---|---|
| ISA | AVX2 | Neon |
| Compiler | GCC 8.0 | GCC 11.0 |
| OS | Ubuntu18.04 | Ubuntu18.04 |

5.2 Comparison with Open Source Frameworks

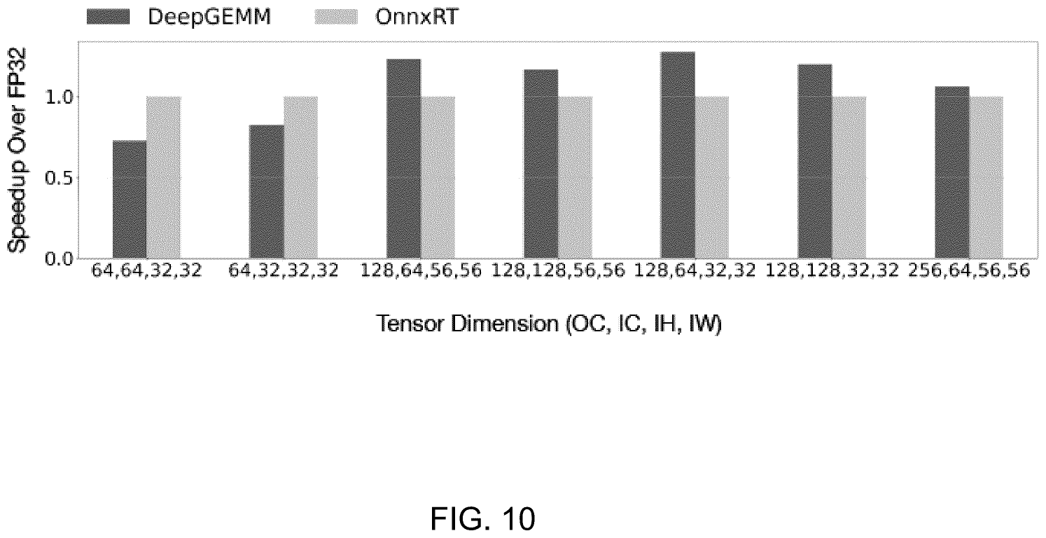

On the x86 platform, the performance on multiple input dimensions of the proposed algorithm were compared against optimized FP32 and INT8 kernels in ONNX Runtime and QNNPACK, respectively. In FIG. 9, the proposed LUT kernels to the INT8 kernels in QNNPACK. The results show significantly lower latencies with up to 1.6× speedup for the proposed approach across all the layers of MobileNetV1. In FIG. 10, the relative speedup of the proposed approach is plotted against the high performance FP32 kernels in ONNX Runtime. The proposed approach offers faster performance compared to the FP32 baseline with larger channel sizes. An interesting observation based on these results is higher speedups realized with the proposed approach as the number of channels go up since the algorithm is vectorized along the channels dimension.

### 5.3 Full Network Performance

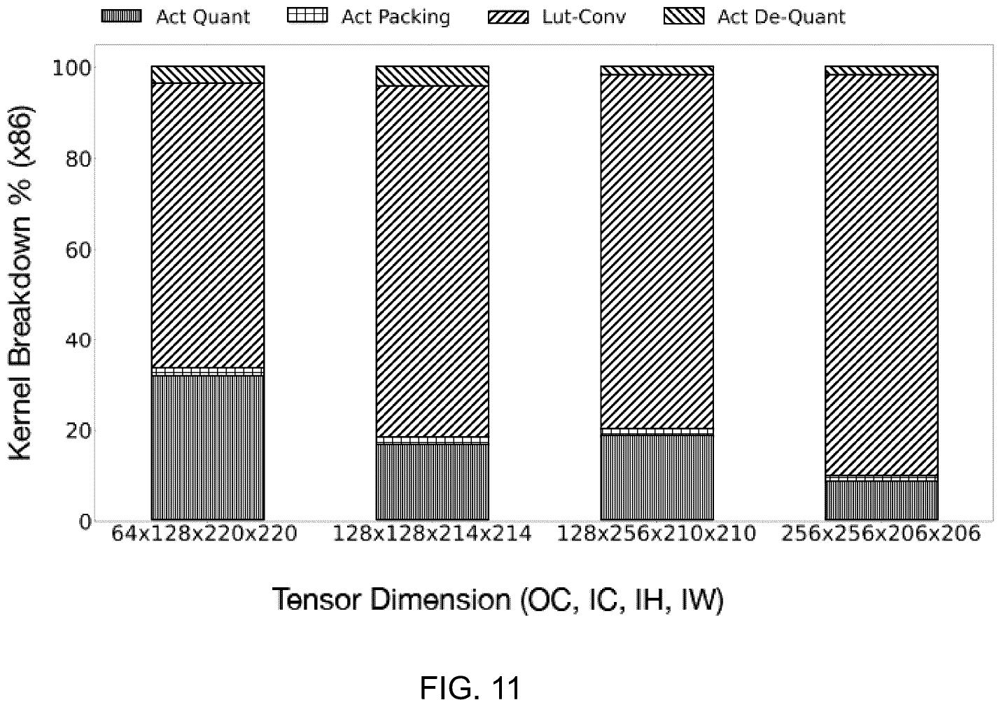

Quantization introduces extra operators into the network for activation quantization and dequantization that can result in additional latency during model inference. For tiny models with small activations, the overhead is negligible but with larger tensor dimensions, it can become significant as demonstrated by FIG. 11. This is a general problem for inference with quantized activations since the intermediate data values are not available offline. With a LUT based algorithm, it is possible to precompute the results of the sequence of quantize, convolution and dequantize operators and store them in the LUT since the scaling factor and other quantization constants are known beforehand.

### 5.4 Low-Level Kernel Profiling

FIG. 11 represents the runtime portion of each step during inference with the proposed approach. Operations are mainly categorized into 1) Activation packing 2) Unpacking, and 3) Lookup. The Intel VTune profiler was used to compare the execution times between the 3 parts of the algorithm on the Intel target and found that the unpacking step within Lut-Conv is the main bottleneck taking about 80% of the overall execution time. Since unpacking fundamentally requires multiple bit-level instructions and has to be performed repeatedly on the packed data, it represents a significant over-head compared to the lookup operation. The ONNX Runtime profiling tool was also used to get the execution times of different operators within the network and found that vectorized packing takes significantly less time the LUT convolution (including unpacking). Interestingly, even though table lookup is the defining feature of the proposed approach, it takes substantially less time compared to both the input packing and unpacking stages. Also, the total memory required for the 65k LUT is 1.1 MB (65536×2 bytes) which can be easily stored in the L2 cache on a modern processor. Finally, it was also observed that there is no memory bound traffic for 65k LUT.

### 6 PROPOSED HARDWARE ARCHITECTURE

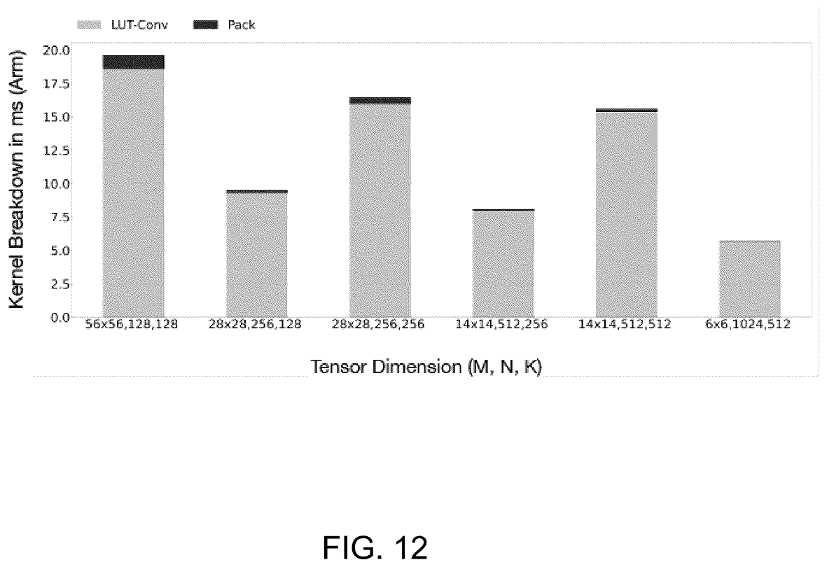

As stated in the previous section, the unpacking stage is the major bottleneck in the proposed algorithm. More efficient packing methods are being explored to reduce the number of instructions required for unpacking. Experimentation is also being conducted with fusion of operators before and after convolution to store precomputed results for a sequence of operators in the LUT to remove the overhead resulting from activation quantization. In addition to the disclosed x86 LUT kernel, the proposed algorithm is extended to Arm using Neon instructions and tested it on the Raspberry Pi 4B device listed in Table 2. FIG. 12 gives a breakdown of the execution time for different layers on the Arm target. The initial Arm implementation uses 64-bit vector registers and it is possible to extend it to 128-bit vector registers to double the throughput and gain competitive performance against optimized baselines. Finally, a custom hardware accelerator based on the proposed algorithm is being designed to be implemented on FPGA, to have a customised architecture to accelerate the computation and reduce the costly memory operations. For the proposed architecture, it is planned to use near-memory computation. This way, the cost of lookup and packing will be dramatically reduced.

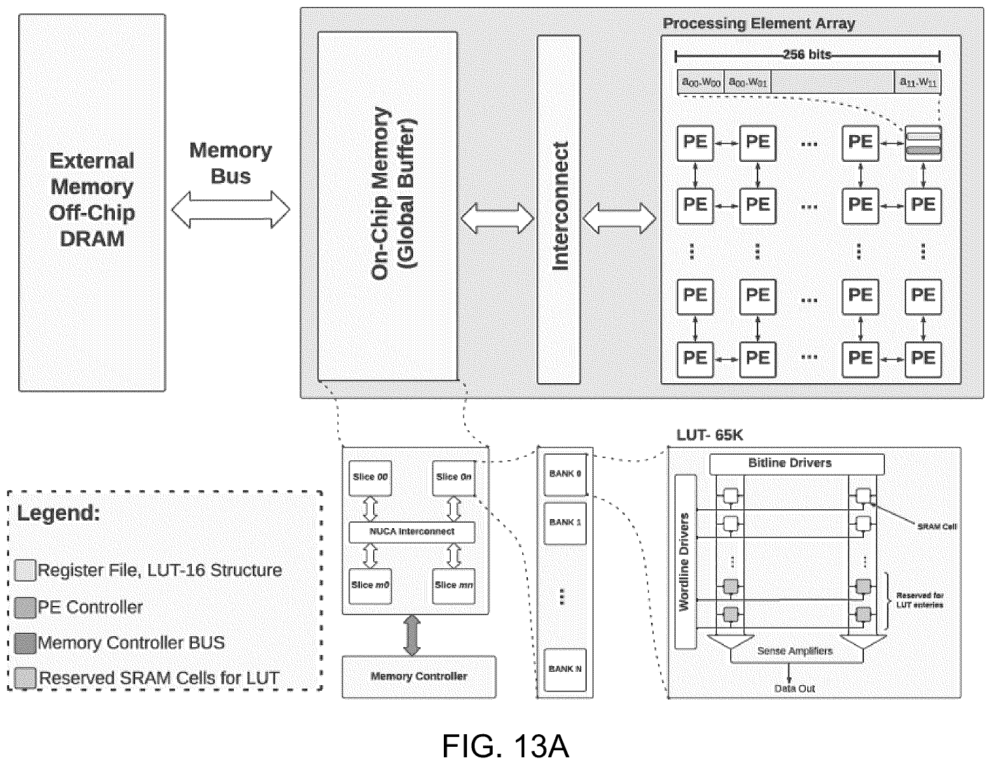

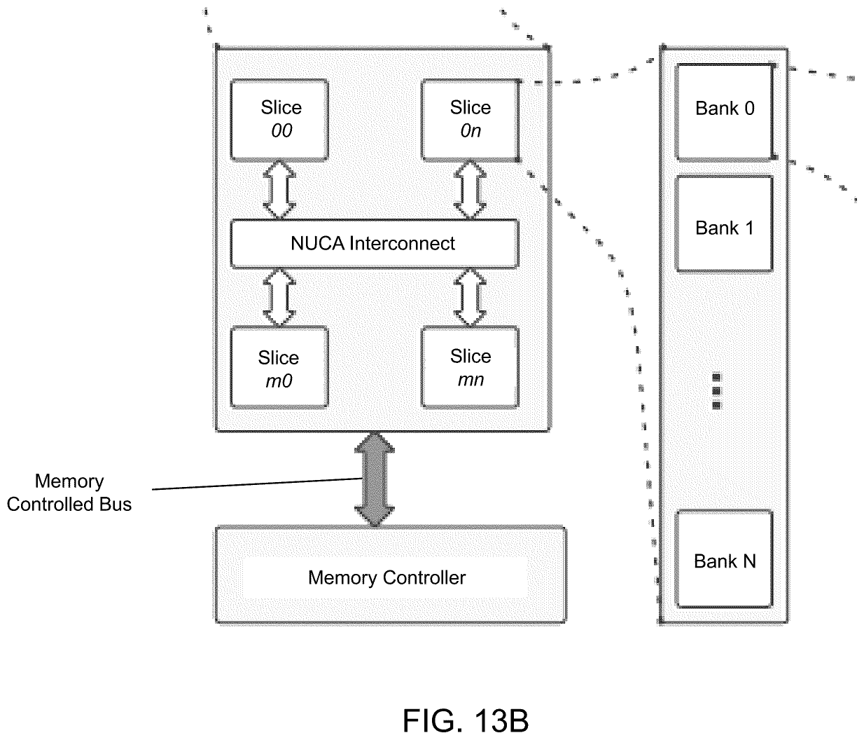

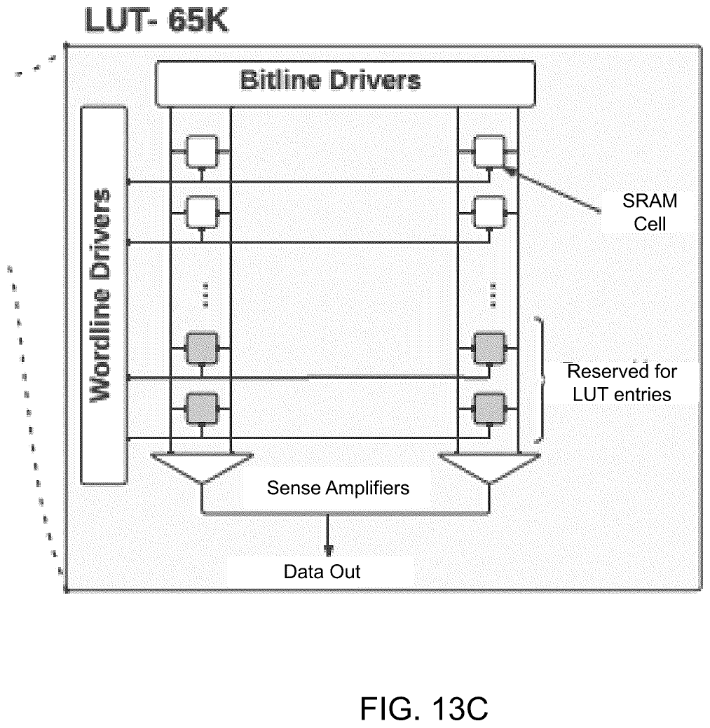

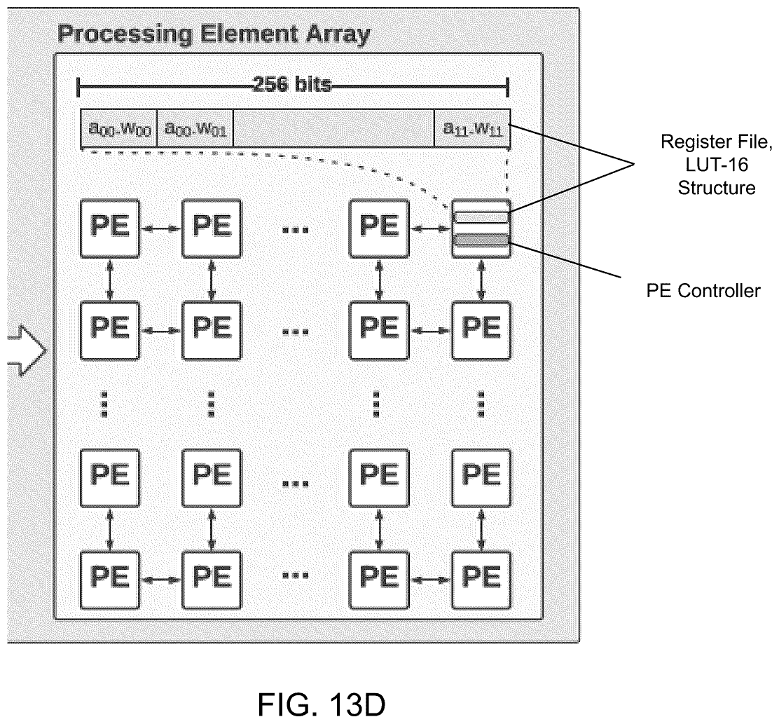

FIGS. 13A, 13B, 13C, and 13D illustrate a proposed custom hardware architecture to accelerate computation for the proposed algorithm. FIGS. 13B, 13C, and 13D show particulars of FIG. 13A in a larger size, for clarity. The proposed algorithm accelerator has a special on chip memory unit that reserves the fast SRAM cells for the proposed LUT-65K elements. Furthermore, the LUT-16 elements will be stored inside each PE, making the time required for lookup operation as low as possible.

### 7 CONCLUSION

In application, a proposed approach is disclosed that uses a lookup table based approach for CPUs that replaces the costly multiply accumulate arithmetic in dot product calculations with simpler indexing operations into preconstructed tables for computing ultra low-precision layers in convolutional neural networks. The faster latency of table lookup coupled with substantially fewer memory accesses for packed ultra low-bit data results in significant gains over optimized floating point and 8-bit integer baselines. Compared to prior works on sub-byte operators, the proposed approach offers more flexibility with support for uniform and non-uniform quantization methods where integer or floating point results can be pre-computed and stored in the lookup table. The approach was implemented in a vectorized kernels for x86 platforms that outperform optimized 8-bit baselines by up to 1.6×.

### Example System Configuration

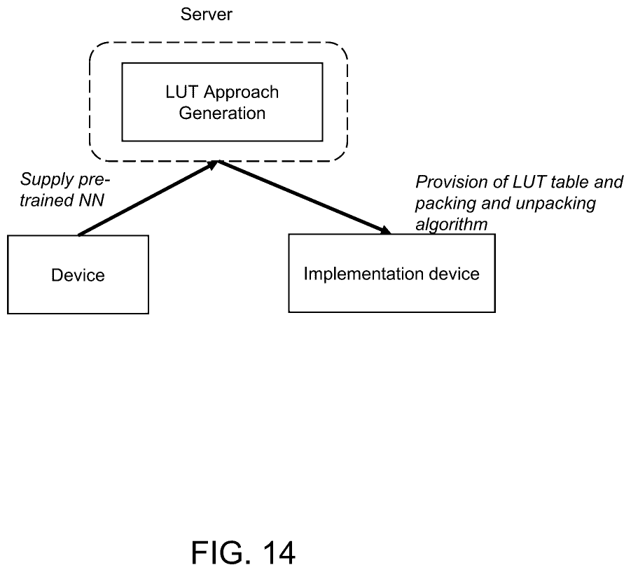

Referring now to FIG. 14, a system is shown in which a neural network processed in accordance with the disclosure and used in an application on other hardware. In this example configuration, a computer server hosts a LUT generating algorithm, and generates the packing and unpacking scheme for the neural network, which can be accessed via a network or other electronic communication connection to permit the LUT table and related algorithms to be supplied thereto by a implementation device. The user can supply a pre-trained neural network (e.g., a quantized network) using a first device. Which may be the device for which the LUT based approached is used, or another separate device. The server applies the principles described above to generate the LUT and related algorithms which can be deployed onto an implementation device. It can be appreciated that the device can be associated with the same user that supplied the pre-trained neural network or a different user.

An implementation device where a user might wish to use their neural network with the LUT is for image classification on camera hardware which does not have access to the latest processors or memory. In such an example, a user could pre-train their neural network using the server-based resources, or the device. Next, the user supplies the pre-trained neural network through the internet (or other network) to a solution server, or a resource with a similar compute power, where the LUT based approach most likely to, or which will, succeed on the implementation device is determined. The LUT based approach would optimize the implementation of the neural network without requiring the user data (i.e., explaining why storage/data are not shown as mandatory) on that server. Subsequently, the LUT based approach and related algorithms are supplied via the network, to the implementation device to perform image classification directly on-device, not requiring any further connection.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server or user's device, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

### REFERENCES

Chen, T., Moreau, T., Jiang, Z., Zheng, L., Yan, E., Shen, H., Cowan, M., Wang, L., Hu, Y., Ceze, L., et al. {TVM}: An automated end-to-end optimizing compiler for deep learning. In 13th {USENIX} Symposium on Operating Systems Design and Implementation ({OSDI} 18), pp. 578-594, 2018.
Cowan, M., Moreau, T., Chen, T., Bornholt, J., and Ceze, L. Automatic generation of high-performance quantized machine learning kernels. In Proceedings of the 18th ACM/IEEE International Symposium on Code Generation and Optimization, CGO 2020, pp. 305-316, New York, NY, USA, 2020. Association for Computing Machinery. ISBN 9781450370479. doi: 10.1145/3368826.3377912. URL https://doi.org/10.1145/3368826.3377912.
Dukhan, M., Wu, Y., and Lu, H. QNNPACK: open source library for optimized mobile deep learning, 2018. URL https://github.com/pytorch/QNNPACK.
Han, Q., Hu, Y., Yu, F., Yang, H., Liu, B., Hu, P., Gong, R., Wang, Y., Wang, R., Luan, Z., and Qian, D. Extremely Low-bit Convolution Optimization for Quantized Neural Network on Modern Computer Architectures. ACM International Conference Proceeding Series, 2020. doi: 10.1145/3404397.3404407.
Hu, Y., Zhai, J., Li, D., Gong, Y., Zhu, Y., Liu, W., Su, L., and Jin, J. Bitflow: Exploiting vector parallelism for binary neural networks on CPU. In 2018 IEEE International Parallel and Distributed Processing Symposium (IPDPS), pp. 244-253. IEEE, 2018.
Jacob, B. et al. gemmlowp: a small self-contained low-precision gemm library.(2017), 2017. URL https://github.com/google/gemmlowp.
Lai, L., Suda, N., and Chandra, V. CMSIS-NN: efficient neural network kernels for arm cortex-m cpus. CoRR, abs/1801.06601, 2018. URL http://arxiv.org/abs/1801.06601.
Sze, V., Chen, Y.-H., Yang, T.-J., and Emer, J. S. Efficient processing of deep neural networks: A tutorial and survey. Proceedings of the IEEE, 105(12)-2295-2329, 2017.
Tencent. NCNN, 2020. URL https://github.com/Tencent/ncnn.
Tulloch, A. and Jia, Y. High performance ultra-low-precision convolutions on mobile devices. CoRR, abs/1712.02427, 2017. URL http://arxiv.org/abs/1712.02427.
Won, J., Si, J., Son, S., Ham, T. J., and Lee, J. W. Ulppack:Fast sub-8-bit matrix multiply on commodity simd hardware. In Marculescu, D., Chi, Y., and Wu, C. (eds.), Proceedings of Machine Learning and Systems, volume 4, pp. 52-63, 2022. URL https://proceedings.mlsys.org/paper/2022/file/14bfa6bb14875e45bba028a21ed38046-Paper.pdf

1. A method for implementing neural networks, the method comprising:
providing a neural network comprising at least one convolution;
providing a lookup table for implementing the at least one convolution;
packing weights and activations of the neural network associated with the at least one convolution with a first set of bitwise operations;
unpacking the packed weights and activations, with a second set of bitwise operations, to determine one or more inputs for the lookup table;
accessing, within the lookup table, an output corresponding to the one or more inputs; and
implementing the at least one convolution based on the output.

2. The method of claim 1, wherein the first set and the second set of bitwise operators consist of at least one of bitwise shift, bitwise OR, and bitwise shuffle operations.

3. The method of claim 1, wherein the method further comprises quantizing the neural network and the lookup table is determined based on convolutions of the quantized neural network.

4. The method of claim 1, wherein the lookup table is used in combination with transformed convolutions.

5. The method of claim 3, wherein the quantization is one of uniform or non-uniform.

6. The method of claim 1, wherein implementing the at least one convolution further comprises aggregating the result of each of the at least one convolution.

7. The method of claim 6, wherein the aggregated results are used to determine whether at least one activation threshold of the neural network is triggered.

8. The method of claim 1, wherein a size of entries of the lookup table is based on the architecture being used to implement the neural network.

9. The method of claim 1, wherein the lookup table is organized according to an ordering of unpacked results of weights of the neural network, the ordering enabling combination via an OR bitwise operator to arrive at the output.

10. The method of claim 1, wherein the lookup table comprises all possible combinations of 4 weights and activations of the neural network.

11. The method of claim 1, further comprising:
training a precursor neural network;
determining a device to implement the pre-cursor network;
determining the lookup table based on the determined device; and
generating the neural network based on the precursor neural network.

12. A computer-readable medium storing computer executable instructions which when executed by a processor of a computing device cause the computing device to:
provide a neural network comprising at least one convolution;
provide a lookup table for implementing the at least one convolution pack weights and activations of the neural network associated with the at least one convolution with a first set of bitwise operations;
unpack the packed weights and activations, with a second set of bitwise operations, to determine one or more inputs for the lookup table;
access, within the lookup table, an output corresponding to the one or more inputs; and
implement the at least one convolution based on the output.

13. A device for implementing neural networks, the device comprising:
a processor;
a memory connected to the processor, and comprising computer executable instructions that when executed by the processor cause the processor to:
provide a neural network comprising at least one convolution;
provide a lookup table for implementing the at least one convolution;
pack weights and activations of the neural network associated with the at least one convolution with a first set of bitwise operations;
unpack the packed weights and activations, with a second set of bitwise operations, to determine one or more inputs for the lookup table;
access, within the lookup table, an output corresponding to the one or more inputs; and
implement the at least one convolution based on the output.

14. The device of claim 13, wherein the first set and the second set of bitwise operators consist of at least one of bitwise shift, bitwise OR, and bitwise shuffle operations.

15. The device of claim 13, wherein the instructions further cause the processor to: quantize the neural network, and wherein the lookup table is determined based on convolutions of the quantized neural network.

16. The device of claim 13, wherein the lookup table is used in combination with transformed convolutions.

17. The device of claim 15, wherein the quantization is one of uniform or non-uniform.

18. The device of claim 13, wherein implementing the at least one convolution further comprises aggregating the result of each of the at least one convolution.

19. The device of claim 18, wherein the aggregated results are used to determine whether at least one activation threshold of the neural network is triggered.

20. The device of claim 13, wherein a size of entries of the lookup table is based on architecture of the device.

21. The device of claim 13, wherein the lookup table is organized according to an ordering of unpacked results of weights of the neural network, the ordering enabling combination via an OR bitwise operator to arrive at the output.

22. The device of claim 13, wherein the lookup table comprises all possible combinations of 4 weights and activations of the neural network.
